(19) United States
(12) Patent Application Publication
(10) Pub. No.: US 2025/0368554 A1
(43) Pub. Date: Dec. 4, 2025

(54) TREATMENT METHOD FOR FLUORINE- AND ALUMINUM-CONTAINING WATER

(71) Applicant: KURITA WATER INDUSTRIES LTD., Tokyo (JP)

(72) Inventor: Hidekuni KAMEDA, Tokyo (JP)

(73) Assignee: KURITA WATER INDUSTRIES LTD., Tokyo (JP)

(21) Appl. No.: 18/867,442

(22) PCT Filed: May 18, 2023
(86) PCT No.: PCT/JP2023/018560

§ 371 Date: Nov. 20, 2024

(30) Foreign Application Priority Data
Jun. 2, 2022 (JP) 2022-090349

(51) Int. Cl. C02F 1/68; C02F 1/44; C02F 101/14

(52) U.S. Cl. CPC C02F 1/683; C02F 1/441; C02F 2101/14; C02F 2209/20; C02F 2305/00

(57) ABSTRACT

The present invention provides a treatment method for fluorine- and aluminum-containing water, in which a chelating agent is added to fluorine- and aluminum-containing water in an amount of 100 times or more by weight of the aluminum concentration in the fluorine- and aluminum-containing water, and then water is passed through a reverse osmosis membrane device. The pH of the fluorine- and aluminum-containing water is preferably 4 to 6. The chelating agent is preferably EDTA. The F ion concentration in the water to be treated is preferably 50 to 700 mg/L, and the Al ion concentration therein is preferably 0.01 to 1 mg/L.

### TECHNICAL FIELD

The present invention relates to a treatment method for fluorine- and aluminum-containing water, and particularly relates to a treatment method for fluorine- and aluminum-containing water that uses reverse osmosis (RO) membrane treatment for the fluorine- and aluminum-containing water.

### DESCRIPTION OF RELATED ART

In manufacturing plants in the electronic industry field, such as electronic displays and semiconductors, various types of chemicals are used. Fluorides such as hydrogen fluoride/hydrofluoric acid (HF), fluoroboric acid (HBF₄), and ammonium fluoride (NH₄F) are used in large quantities, mainly in production processes such as etching and cleaning. Thus, large amounts of wastewater containing such fluorides are generated from the processes. In particular, wastewater containing fluorides and silica is discharged from the etching process of silicon wafers. In addition, from processes where ammonium fluoride is used, wastewater containing ammonium components is also discharged.

Conventionally, as a treatment method for fluoride-containing water, a method of treating fluoride-containing water with RO membrane and recovering desalinated water is widely known. For example, Patent Literature 1 describes a method in which heavy metal-containing wastewater with a fluorine concentration of 4 to 43 mg/L is subjected to pH adjustment, followed by coagulation treatment, and then RO treatment. Patent Literature 1 does not describe that the heavy metal-containing wastewater includes aluminum.

Patent Literature 2 describes a method in which mixed water of industrial water containing Ca ions and electronic component manufacturing wastewater containing F ions is adjusted to pH 3 to 6, followed by the addition of EDTA as a chelating agent, and then subjected to RO treatment. Patent Literature 2 does not describe that the mixed water includes aluminum.

Patent Literature 3 describes a method in which calcium salt is added to electronic component manufacturing process wastewater, followed by coagulation treatment, then solid-liquid separation treatment, addition of a chelating agent, and subsequently RO treatment. The example in Patent Literature 3 describes a method in which raw water containing Ca, Mg, Al, P, NH₄, F, and Si, with an F concentration of 565 mg/L and an Al concentration of 0.2 mg/L, is subjected to coagulation treatment, followed by solid-liquid separation, then addition of 0.0025 mmol/L of EDTA, and subsequently RO treatment. However, there is no description regarding the Al concentration in the RO feed water.

### Related Art

### Patent Literature

Patent Literature 1: Japanese Patent Application Laid-Open No. 2003-340450

Patent Literature 2: Japanese Patent Application Laid-Open No. 2001-104955

Patent Literature 3: Japanese Patent Application Laid-Open No. 2014-213264

### SUMMARY

### Technical Problem

In the case of RO treatment of fluorine- and aluminum-containing water, it has been discovered that, depending on the concentrations of fluorine and aluminum and pH conditions, cryolite and other substances may precipitate on the RO membrane surface, resulting in a decrease in flux (permeation flux).

The present invention aims to provide a treatment method for fluorine- and aluminum-containing water that is capable of suppressing the decrease in RO flux caused by aluminum.

### Solution to the Problem

The treatment method for fluorine- and aluminum-containing water of the present invention includes: a chelating agent is added to fluorine- and aluminum-containing water in an amount of 100 times or more by weight of an aluminum concentration in the fluorine- and aluminum-containing water, and then water is passed through a reverse osmosis membrane device.

In an embodiment of the present invention, the pH of the fluorine- and aluminum-containing water is 4 to 6.

In an embodiment of the present invention, the chelating agent is EDTA.

### Effects

According to the treatment method for fluorine- and aluminum-containing water of the present invention, the decrease in RO flux in the case of RO treatment of fluorine and aluminum may be suppressed, and treatment may be efficient.

### BRIEF DESCRIPTION OF THE DRAWINGS

FIGS. 1(a) and (b) are configuration diagrams of test apparatuses used in an Example and a Comparative Example.

FIG. 2 is a graph showing the results of an Example and a Comparative Example.

FIG. 3 is a graph showing the results of an Example and a Comparative Example.

### DESCRIPTION OF EMBODIMENTS

The present invention is described in further detail below.

### Water to be Treated

As the water to be treated in the method of the present invention, process wastewater using F may be exemplified, among which electronic component manufacturing process wastewater is particularly suitable.

In the water to be treated, the F ion concentration is preferably 50 to 700 mg/L, particularly 50 to 150 mg/L, and the Al ion concentration is preferably 0.01 to 1 mg/L, particularly 0.01 to 0.1 mg/L.

The following may be cited as other main ion concentrations.
Na: 20 to 200 mg/L, particularly 100 to 150 mg/L
Ca: 0 to 50 mg/L, particularly 0.01 to 1 mg/L
Fe: 0 to 50 mg/L, particularly 0.01 to 1 mg/L
Mg: 0 to 50 mg/L, particularly 0.01 to 1 mg/L
Mn: 0 to 50 mg/L, particularly 0.01 to 1 mg/L
Si: 0 to 100 mg/L, particularly 0 to 50 mg/L
NH4⁺ (as NH₄—N): 20 to 200 mg/L, particularly 20 to 100 mg/L

The TOC concentration in the water to be treated is preferably 0 to 10 mg/L, particularly approximately 0 to 3 mg/L.

The pH of the water to be treated is not particularly limited, but it is preferable to adjust the pH using NaOH, hydrochloric acid, sulfuric acid, etc., as needed, so that the pH of the RO feed water becomes 4 to 6, particularly approximately 5.0 to 5.5.

The water to be treated is preferably subjected to turbidity removal treatment as needed. Examples of turbidity removal treatment include sand filtration and UF membrane filtration.

### Chelating Agent

In the present invention, a chelating agent is added to the RO feed water in an amount of 100 times or more by weight, preferably 100 to 1500 times by weight, more preferably 200 to 1500 times by weight, and particularly preferably 300 to 1500 times by weight, with respect to the Al concentration in the RO feed water.

As the chelating agent, EDTA (ethylenediaminetetraacetic acid) is preferable, but citric acid, etc. may also be used. The chelating agent is preferably added as an aqueous solution.

### EXAMPLE

### Example 1

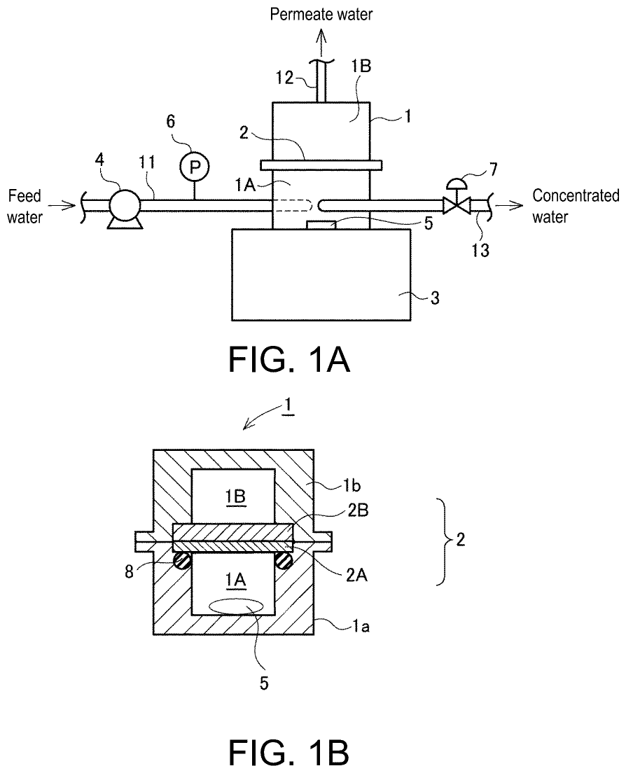

Using the flat membrane test apparatus shown in FIGS. 1(a) and (b), RO treatment was performed on the wastewater with the water quality shown below by adding EDTA at 100 mg/L. The ratio of EDTA/Al=100/0.07=1429.

The wastewater is obtained by concentrating electronic component manufacturing process wastewater using a UF membrane.

### Water Quality of the Wastewater

Al: 0.07 mg/L
Na: 113 mg/L
F: 138 mg/L
Si: 7.5 mg/L
pH: 5.0
Silica-based scale inhibitor: 20 mg/L

The RO membrane used in the flat membrane test apparatus shown in FIGS. 1(a) and (b) was “ES20” manufactured by Nitto Denko Corporation, and the recovery rate was set to 80%.

In the flat membrane test apparatus, RO membrane feed water is supplied from a pipe 11 by a high pressure pump 4 to a raw water chamber 1A below a flat membrane cell 2 in which an RO membrane is set in a sealed container 1. As shown in FIGS. 1(b), the sealed container 1 is composed of a lower case 1a on the raw water chamber 1A side and an upper case 1b on a permeate water chamber 1B side, and the flat membrane cell 2 is fixed between the lower case la and the upper case 1b via an O-ring 8. The flat membrane cell 2 is configured such that the permeate water side of an RO membrane 2A is supported by a porous support plate 2B. The inside of the raw water chamber 1A below the flat membrane cell 2 is stirred by rotating a stirring bar 5 with a stirrer 3. The RO membrane permeate water passes through the permeate water chamber 1B above the flat membrane cell 2 and is taken out through a pipe 12. The concentrated water is taken out through a pipe 13. The pressure inside the sealed container 1 is adjusted by a pressure gauge 6 provided on the water supply pipe 11 and a pressure regulating valve 7 provided on the concentrated water extraction pipe 13.

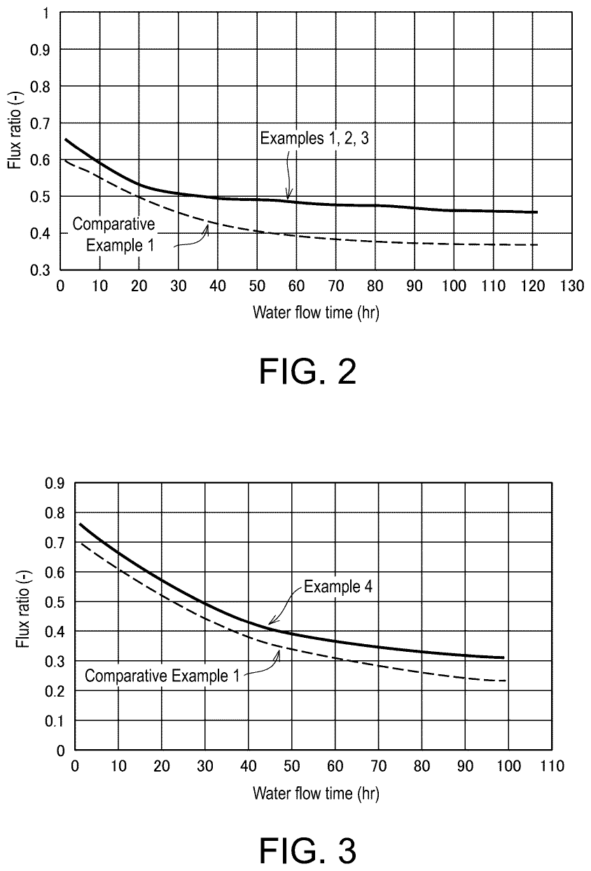

FIG. 2 shows the time-dependent change of the flux ratio when the above-mentioned wastewater is passed through the flat membrane test apparatus. The flux ratio represents the ratio to the initial pure water flux.

### Examples 2 and 3, Comparative Example 1

Tests were conducted under the same conditions as in Example 1. except that the amount of EDTA added was as follows. The time-dependent change of the flux ratio is shown in FIG. 2.
Example 2: 80 mg/L (EDTA/Al=1143)
Example 3: 60 mg/L (EDTA/Al=857)
Comparative Example 1:0 mg/L (EDTA/Al=0)

### <Consideration>

As shown in FIG. 2, in Examples 1 to 3 in which EDTA was added at approximately 800 to 1500 times the amount of Al, the decrease in flux was suppressed compared to Comparative Example 1 in which EDTA was not added.

### Example 4, Comparative Example 2

In Example 2 and Comparative Example 1, wastewater with an Al concentration of 0.2 mg/L was treated by adding reagent aluminum chloride to the above-mentioned wastewater.

The amount of EDTA added was the same as in Example 2 and Comparative Example 1.
Example 4: 80 mg/L (EDTA/Al=80/0.2=400)
Comparative Example 2: 0 mg/L (EDTA/Al=0)
The time-dependent change of the flux ratio is shown in FIG. 3.

As shown in FIG. 3, it was recognized that the decrease in flux was suppressed by adding EDTA at 400 times the amount of Al.

Although the present invention has been described in detail using specific embodiments, it will be apparent to those skilled in the art that various modifications can be made without departing from the spirit and scope of the present invention.

The present application is based on Japanese Patent Application Laid-Open No. 2022-090349 filed on Jun. 2, 2022, which is incorporated by reference in its entirety.

### REFERENCE SIGNS LIST

1: Container
2: Flat membrane cell
2A: RO membrane
2B: Porous support plate
3: Stirrer
4: High pressure pump
5: Stirring bar
10 6: Pressure gauge
7: Pressure regulating valve
8: O-ring

1. A treatment method for fluorine- and aluminum-containing water, comprising:
adding a chelating agent to fluorine- and aluminum-containing water in an amount of 100 times or more by weight of an aluminum concentration in the fluorine- and aluminum-containing water; and
passing water through a reverse osmosis membrane device.

2. The treatment method for fluorine- and aluminum-containing water according to claim 1, wherein a pH of the fluorine- and aluminum-containing water is 4 to 6.

3. The treatment method for fluorine- and aluminum-containing water according to claim 1, wherein the chelating agent is EDTA.

4. The treatment method for fluorine- and aluminum-containing water according to claim 1, wherein the chelating agent is added to the fluorine- and aluminum-containing water in an amount of 100 to 1500 times by weight of the aluminum concentration in the fluorine- and aluminum-containing water.

5. The treatment method for fluorine- and aluminum-containing water according to claim 1, wherein the chelating agent is added to the fluorine- and aluminum-containing water in an amount of 800 to 1500 times by weight of the aluminum concentration in the fluorine- and aluminum-containing water.

6. The treatment method for fluorine- and aluminum-containing water according to claim 1, wherein an F ion concentration in the fluorine- and aluminum-containing water is 50 to 700 mg/L, and an Al ion concentration is 0.01 to 1 mg/L.

7. The treatment method for fluorine- and aluminum-containing water according to claim 1, wherein a TOC concentration in the fluorine- and aluminum-containing water is 10 mg/L, or less.
